(19) United States
(12) Patent Application Publication
(10) Pub. No.: US 2021/0072975 A1
(43) Pub. Date: Mar. 11, 2021

(54) VEHICLE ECU FLASH PROGRAMMING

(71) Applicant: Ford Global Technologies, LLC, Dearborn, MI (US)

(72) Inventors: Hafiz Shafeek Khafagy, Dearborn, MI (US); Ali Badreddine, Dearborn Heights, MI (US); Abdalla Artail, Dearborn, MI (US); Tomas Bacci, Detroit, MI (US)

(73) Assignee: Ford Global Technologies, LLC, Dearborn, MI (US)

(21) Appl. No.: 16/564,670

(22) Filed: Sep. 9, 2019

(51) Int. Cl. G06F 8/654; H04L 29/08; G06F 11/14

(52) U.S. Cl. CPC G06F 8/654; H04L 67/12; H04W 4/48; G06F 11/1469; G06F 11/1464; H04L 67/34

(57) ABSTRACT

An electronic control unit in a vehicle is provided. The electronic control unit includes a processor and a memory. The memory stores instructions, executable by the processor to receive a software update, broadcast a flash initiation message via a vehicle communications network, flash the software update, and broadcast a flash outcome including a flash success or a flash failure.

### BACKGROUND

Diagnostic trouble codes or the like are useful for reporting vehicle faults. However, false trouble codes can disrupt vehicle development, vehicle production, vehicle operation, and vehicle service. Flash programming an electronic control unit in a vehicle can result in one or more false diagnostic trouble codes or the like.

### BRIEF DESCRIPTION OF THE DRAWINGS

FIG. 1 is a block diagram illustrating an example system for vehicle ECU flash programming.

FIG. 2 illustrates an example process for vehicle ECU flash programming.

### DETAILED DESCRIPTION

A first electronic control unit in a vehicle comprises a processor and a memory. The memory stores instructions, executable by the processor to receive a software update, broadcast a flash initiation message via a vehicle communications network, flash the software update, and broadcast a flash outcome including a flash success or a flash failure. The first electronic control unit can be further programmed to store in the memory a diagnostic trouble code generated during the flash. The first electronic control unit can be further programmed to receive and store in the memory a diagnostic trouble code existing in the memory prior to flash. The first electronic control unit can be further programmed to back up the diagnostic trouble code in a memory partition section of the memory prior to broadcast of the flash initiation message. The first electronic control unit can be further programmed to erase the diagnostic trouble code generated during the flash. The first electronic control unit can be further programmed to determine if the memory includes the diagnostic trouble code generated during the flash following broadcast of the flash success. The first electronic control unit can be further programmed to restore the diagnostic trouble code from backup following broadcast of the flash failure, following the erasure of the diagnostic trouble code generated during the flash, or following the determination that the memory does not include the diagnostic trouble code generated during the flash.

A system in a vehicle comprises a first electronic control unit and a second electronic unit. The second electronic control unit is communicatively coupled to the first electronic control unit via a vehicle communications network. The first electronic control unit is programmed to receive a software update, broadcast a flash initiation message via the vehicle communications network, flash the software update, and broadcast a flash outcome including a flash success or a flash failure. The first electronic control unit is further programmed to store in the memory a diagnostic trouble code generated during the flash. The first electronic control unit is further programmed to receive and store in the memory a diagnostic trouble code existing in the memory prior to flash. The first electronic control unit is further programmed to backup the diagnostic trouble code in a memory partition section of the memory prior to the flash initiation broadcast. The first electronic control unit is further programmed to erase the diagnostic trouble code generated during the flash. The first electronic control unit determines if the memory includes the diagnostic trouble code generated during the flash following broadcast of the flash success. The first electronic control unit is further programmed to restore the diagnostic trouble code existing in the memory prior to flash from backup following broadcast of the flash failure, following the erasure of the diagnostic trouble code generated during the flash, or following the determination that the memory does not include the diagnostic trouble code generated during the flash.

A method comprises, by a first electronic control unit in a vehicle, receiving a software update; broadcasting a flash initiation message via a vehicle communications network; flashing the software update; and broadcasting a flash outcome including a flash success or a flash failure. The first electronic control unit stores in memory a diagnostic trouble code generated during flashing. The first electronic control unit receives and stores in memory a diagnostic trouble code existing in the memory prior to flashing. The first electronic control unit backs up the diagnostic trouble code existing in the memory prior to flashing in a memory partition section prior to broadcasting flash initiation. After broadcasting the flash success, the first electronic control unit erases the diagnostic trouble code generated during the flash. The first electronic control unit restores the diagnostic trouble code from backup following broadcasting of the flash failure, following erasing of the diagnostic trouble code generated during the flash, or following determining that the memory does not include the diagnostic trouble code generated during the flash.

Electronic control units (ECUs) onboard a vehicle can be initially programmed, e.g., at a manufacturing facility, with software to control an ECU's operation, e.g., for processing various sensor inputs and requests from other onboard electronic control units, for providing control signals to vehicle components, etc. After the initial programming, e.g., in the manufacturing facility or once a vehicle has left the manufacturing facility, an ECU in the vehicle can be flash-programmed with software updates to provide enhanced features, bug fixes, etc. According to techniques herein, false trouble codes resulting from flash programming a vehicle electronic control unit (ECU) can be reduced.

“Flash programming” as used herein has the commonly understood meaning of an overwrite of core software on non-volatile memory (i.e., that typically otherwise cannot be changed) of a computing device such as an ECU. The terms “update”, “software update”, “updated software”, or the like refer not only to the download and installation of patches and improvements to already existing software, but also to the download and installation of software applications that are entirely new as well as updates to firmware and configuration settings. After a successful flash programming, the electronic control unit can resume normal operation with the updated software. Flash programming can be done manually using a diagnostic or service tool or by over-the-air (OTA) flashing as is known.

Example trouble codes (also referred to as fault codes) include Diagnostic Trouble Codes (DTCs) or OBD2 Trouble Codes and the like. In general, trouble codes are codes that an electronic control unit may generate and receive via the vehicle communications network such as a Controller Area Network (CAN) communications bus. A diagnostic trouble code (DTC) is typically a unique numeric code specifying a vehicle fault condition and can be associated with a fault condition, a diagnostic condition, a diagnostic status, etc. When the electronic control unit detects a fault in a vehicle component, it will activate the corresponding diagnostic trouble code. A vehicle stores the diagnostic trouble code in ECU memory when it detects a component or system that is not operating within acceptable limits. The diagnostic trouble code helps identify the vehicle fault condition so that it can be diagnosed and repaired.

Vehicle ECUs are interconnected via a vehicle communications network such as a Controller Area Network (CAN) communications bus as described further below, allowing communication with each other. Thus, an electronic control unit may receive a diagnostic trouble code from an interconnected ECU via the vehicle communications network. Flash programming “target software” of a “target electronic control unit” in a vehicle can temporarily interrupt communication between it and an interconnected ECU and cause the interconnected ECU to generate a diagnostic trouble code because, for example, the interconnected ECU detects the loss of communication as a result of the flash. Flash programming can also cause the target electronic control unit itself to generate a diagnostic trouble code during flash programming, as a side effect of the flash programming. A “target electronic control unit” is an electronic control unit determined to require a software update. “Target software” is the software, firmware, and configuration settings in the non-volatile memory of the target electronic control unit that are to be updated by flash programming.

The diagnostic trouble code generated during flash programming is a “false trouble code” because it was generated from the flash programming, rather than from actual detection of a vehicle fault condition as further described below. That is, during flash programming, control units 108b that normally interface with the target electronic control unit 108a can generate trouble codes because the control units 108b can detect an absence of data expected from the target control unit 108a, which is unable to provide the missing data because of the flash process. As a result of a flash programming, trouble codes (such as OBD2 U-codes) can be set erroneously due to a temporary loss of communication between the target electronic control unit and an electronic control unit communicatively coupled to the target electronic unit. During normal operation, electronic control units 108 provide messages to one another at a specified rate. On the receiving end, the intervals between message receptions are monitored. When a particular message is not received for a specified period, a trouble code (e.g., a U-code) will be set (i.e., generated by the ECU 108 and provided on the vehicle 101 CAN bus or the like). Flash programming interrupts communication between the target ECU 108a and one or more interconnected electronic control units 108b, resulting in the setting (i.e., generating) of a trouble code; such trouble code is a false trouble code because the communication loss is only due to the flash programming, and not an actual communication error or failure.

For example, if an interconnected electronic control unit 108b normally receives message carrying a torque request from the target ECU 108a, and the interconnected ECU 108b did not receive the message for x milliseconds (ms) (i.e., the specified interval for receiving the messages), the interconnected ECU 108b will set a trouble code (e.g., a U-Code) to indicate the missing torque request. During normal operation, a trouble code in this context is desirable, as it indicates a valid fault condition (i.e., a communication error or failure between the target ECU 108a and the interconnected ECU 108b) that may need to be resolved through external intervention (whether due to a problem with the CAN bus, an error with the message being transmitted, etc.). The trouble code can be stored in the internal memory 111 of the ECU 108 that generated it.

False trouble codes can result in impairments or changes to vehicle operation, e.g., a control unit 108 could be programmed to limit or change operation of a component 120 based on a trouble code, and/or communications between control units 108 could be changed or prevented. Thus, a false trouble code can needlessly and/or negatively affect vehicle development, production, operation, and/or service. Further false trouble codes can mislead and frustrate users, particularly if they trigger a malfunction indicator light (MIL), such as a Check Engine Light. In addition, false trouble codes currently need to be erased from the memory by using a power cycle or risk being re-confirmed upon a fast key-cycle. Power cycles are time-consuming.

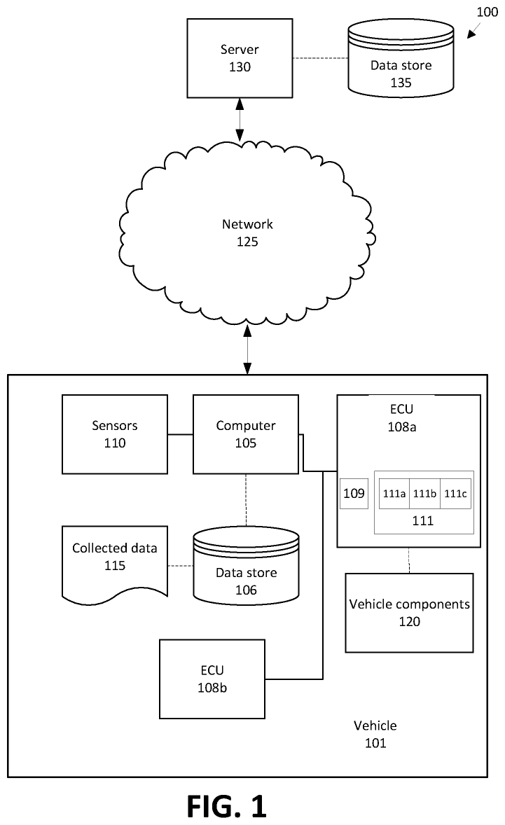

FIG. 1 illustrates an example system 100 for reducing false trouble codes resulting from flash programming a vehicle. A vehicle 101 includes a computer 105 comprising a processor and a memory. The vehicle 101 further includes electronic control units 108a and 108b (referred to generically as control units 108) that are computing devices that each include a processor 109 and a memory 111. While only one computer 105 and two electronic control units 108a and 108b are shown for ease of illustration, it is to be understood that vehicle 101 can include a plurality of computers 105 and/or more than two electronic control units 108a and 108b. Indeed, a vehicle 101 typically includes more than two onboard electronic control units 108, each for monitoring and/or controlling respective components 120. The memory 111 of electronic control units 108 may store one or more instructions executable by the processor and pertaining to the operation of the vehicle 101, the component, a system, or any combination thereof. The memory 111 of the electronic control units 108 can be partitioned into sections (e.g., memory 111a-111c of electronic control unit 108a of FIG. 1) for use by resident programs. For example, the memory 111 of electronic control units 108 can include a section (e.g., 111a, 111b, or 111c) that serves as a backup memory. In the examples discussed below, electronic control unit 108a is a “target” electronic control unit and electronic control unit 108b is an “interconnected” electronic control unit (as those terms are defined below). It is to be understood that ECUs 108a, 108b are designated as such for facilitating the current illustration; typically any ECU 108 in the vehicle 101 could, at various times, be a target ECU 108a or an interconnected ECU 108b.

The computer 105 may include or be communicatively coupled to (e.g., via a vehicle communications network such as a communications bus as described further below) the electronic control units 108 included in the vehicle 101. The computer 105 can be programmed to receive collected data 115 from one or more sensors 110 and/or electronic control units. Collected data 115 is typically available from a vehicle controller area network (CAN) bus or the like. In general, collected data 115 may include data about operation of the vehicle 101, e.g., data about one or more vehicle components 120 as well as data about a location of the vehicle 101, data about an environment around a vehicle, data about an object outside the vehicle such as another vehicle, etc. A vehicle 101 location is typically provided in a conventional form, e.g., geo-coordinates such as latitude and longitude coordinates obtained via a navigation system that uses the Global Positioning System (GPS). Further examples of data 115 can include measurements of vehicle systems and components, e.g., a vehicle velocity, a vehicle trajectory, etc. In general, collected data 115 may include any data that may be gathered by the sensors 110 and/or computed from such data. The data store 106 can be of any type, e.g., hard disk drives, solid state drives, servers, or any volatile or non-volatile media. The data store 106 can store the collected data 115 sent from the sensors 110. Collected data 115 can also include diagnosis data related to malfunctions or other operating conditions of the respective vehicle component 120. An ECU 108 can also receive diagnosis data related to malfunctions or other operating conditions from other interconnected ECUs 108. The diagnosis data may include trouble codes such as DTCs that may be stored to the memory 111 of an electronic control unit 108.

Computing devices 105, 108 in the vehicle 101 are generally programmed for communications on a vehicle communications network, e.g., including a conventional vehicle communications bus. Via the network (such as a controller area network (CAN) or the like, bus, and/or other wired or wireless mechanisms (e.g., a wired or wireless local area network in the vehicle 101), devices 105, 108 may transmit or broadcast messages to each other and/or to other various devices in a vehicle 101 and/or receive messages from the various devices, e.g., actuators, sensors 110, etc. Alternatively, or additionally, in cases where a device 105, 108 comprises multiple devices, the vehicle network may be used for communications between devices represented as the computer 105 or the controller 108 in this disclosure. In addition, the computer 105 may be programmed for communicating with the network 125, which, as described below, may include various wired and/or wireless networking technologies, e.g., cellular, Bluetooth®, Bluetooth® Low Energy (BLE), wired and/or wireless packet networks, etc. “Broadcasting” or the like refers to communicating via the vehicle communications network.

As explained previously, electronic control units 108 can monitor and/or control vehicle components 120 and typically are capable of self-diagnosis. Non-limiting examples of ECUs 108 include an engine control unit, a door control unit, an electric power steering control unit, a powertrain control module, a seat control unit, a telematics control unit, a speed control unit, a transmission control unit, a brake control module, etc.

Various electronic control units 108 in a vehicle 101 may provide data 115 to computer 105 and other electronic control units 108 via the vehicle network or bus, e.g., data 115 relating to component status, etc. For example, the vehicle component 120 may have a fault. A fault is a condition in which the vehicle component fails to operate or operates outside of one or more predefined parameters (e.g., a predefined parameter could be a physical quantity or range of quantities such as temperature, torque, revolutions per minute, pressure, etc.). An electronic control unit 108 may be programmed to determine whether a vehicle component 120 is in a fault condition based on data received from, e.g., various vehicle sensors 110, actuators, other electronic control units 108, etc. A fault condition can include communication failures, e.g., a message or signal with incorrect or missing data, or a message or signal that is not received at all, between electronic control units 108. An ECU 108 is programmed to record (i.e., store) the diagnostic status in the memory 111 thereof when a fault condition is detected. Each diagnostic status may be identified by a trouble code such as a DTC.

Sensors 110 can include a variety of devices, e.g., cameras, motion detectors, etc., i.e., sensors 110 to provide data 115 for evaluating a position of a component, evaluating a slope of a roadway, etc. The sensors 110 could, without limitation, also include short range radar, long range radar, LIDAR, and/or ultrasonic transducers.

The vehicle 101 can include a plurality of vehicle components 120, as mentioned above. In this context, each vehicle component 120 includes one or more hardware components adapted to perform a mechanical function or operation—such as moving the vehicle 101, slowing or stopping the vehicle 101, steering the vehicle 101, etc. Non-limiting examples of components 120 include a propulsion component (that includes, e.g., an internal combustion engine and/or an electric motor, etc.), a transmission component, a steering component (e.g., that may include one or more of a steering wheel, a steering rack, etc.), a suspension component, a brake component (as described below), a park assist component, an adaptive cruise control component, an adaptive steering component, a movable seat, a vehicle body, and the like. Sensors 110 and actuators can also be considered vehicle components 120.

The system 100 can further include a wide area network 125 connected to a server 130 and a data store 135. The computer 105 can further be programmed to communicate with one or more remote sites such as the server 130, via the network 125, such remote site possibly including a data store 135. The network 125 represents one or more mechanisms by which a vehicle computer 105 may communicate with a remote server 130. Accordingly, the network 125 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

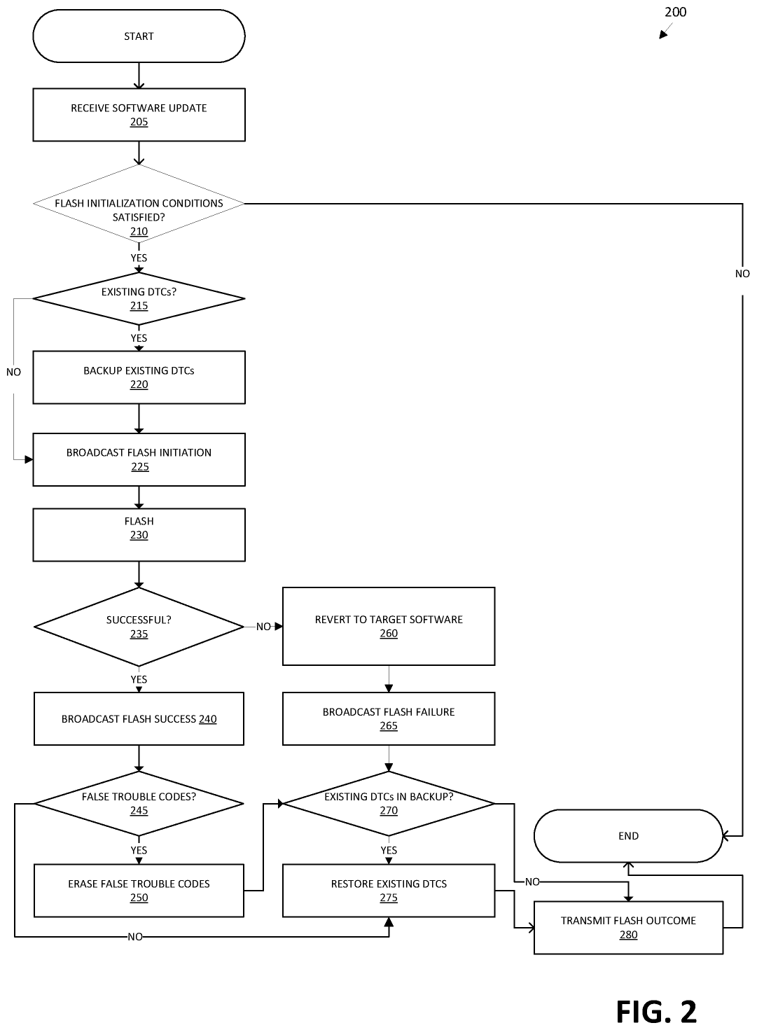

Referring now to FIG. 2, an exemplary process 200 for vehicle ECU flash programming is illustrated. The process 200 is described herein as carried out by program instructions stored in a memory 111 and executable by a processor 109 of a target electronic control unit 108a. As explained previously, the software, firmware, and configuration settings of electronic control units can be “updated” by flash programming, but false trouble codes can result from flash programming. As explained in more detail below with reference to exemplary process 200 (FIG. 2), a target electronic control unit 108a can be programmed to prevent or at least reduce false trouble codes generated from flash programming.

As explained previously, flash programming of a control unit 108 can be done manually using a diagnostic or service tool or by over-the-air (OTA) flashing by various techniques. For example, in an exemplary OTA flashing process initiated by a vehicle requesting a software update, vehicle 101 can connect to the remote server 130 for the software update. Various validation processes may be implemented to ensure the request for update is a viable one, and once these processes are completed, the remote server 130 may acquire vehicle data. Non-limiting examples of vehicle data include software versions, various component installations, etc. This can include identifiers for after-market components, as well as confirmation that various OEM installed components are still installed. Although the remote server 130 can keep a record of the configuration of a vehicle, it may still be useful to verify this information before proceeding with the software update. Once a software version has been received (and confirmed with stored data), the version can be compared to a database containing the most recent software for a vehicle of a particular configuration.

Process 200 begins in block 205 when a target electronic control unit 108a receives a software update or a message indicating a software update is forthcoming. The target electronic control unit 108a can receive the software update via a diagnostic or service tool and/or from over-the air flashing processes using, for example, remote server 130.

Next, in a decision block 210, target electronic control unit 108a determines whether flash initialization conditions are satisfied, e.g., according to a conventional flash initialization process in which a device (e.g., control unit 108a) is to receive a flash programming update. Exemplary flash programming conditions to be satisfied typically include verifying and validating the target ECU 108a, verifying that the target ECU 108a requires a software update (i.e., that the target software is not current), that the target electronic control unit 108a has entered a programming/reprogramming state, etc. When the flash initialization conditions are satisfied, process 200 continues to block 215. Otherwise, the process 200 ends.

Next, in a decision block 215, the target electronic control unit 108a determines if there are any trouble codes already existing in the memory 111 of the target electronic control unit 108a. Existing trouble codes are any that were broadcast prior to flash programming of target electronic control unit 108a from interconnected ECU(s) 108 (such as ECU 108b) via the vehicle 101 communications network. If it is determined that there are diagnostic trouble codes already existing in memory 111 of the target electronic control unit 108a, the process proceeds to a block 220. Otherwise, the process proceeds to a block 225.

In the block 220, which may follow the block 215, the target electronic control unit 108a backs up the existing diagnostic trouble code in, for example, a backup memory 111a, 111b, 111c (FIG. 1) of memory 111. The target electronic control unit 108a is programmed to back up (store) the existing diagnostic trouble code in, for example, the backup memory partition section or in other memory device.

Next, in block 225, the target electronic control unit 108a broadcasts a flash initiation (i.e., an intent to flash) message via the vehicle 101 communications network, e.g., to be received by one or more interconnected electronic control units 108. Upon receipt of the flash initiation message, other control units 108 can execute programming to enter a “vehicle flashing mode,” discussed further below. Vehicle control units 108 can be programmed to, upon receipt of a message specifying that a vehicle flashing mode has commenced, suppress generation of trouble codes resulting from flash programming for a specified period of time and/or until receiving a message that the vehicle flashing mode is completed or terminated. Trouble codes generated from fault conditions that do not involve the target electronic control unit 108a are not suppressed. For example, where the target electronic unit 108a is communicating normally with other control units 108b, and the target electronic control unit 108a is flashed, the other control units 108b receive a flash initiation message notifying them not to set a trouble code related to communication with the target electronic control unit 108a (i.e., because a trouble code for a target ECU 108a while the ECU 108a is being flashed would be a false trouble code). Other ECUs 108b can however, generate a trouble code relating to ECUs 108b other than the target ECU 108a being flashed, e.g., where a communication issue failure or error is present between the other ECUs 108b. In addition, the generation of trouble codes by the target electronic control unit 108a itself, if any, as a result of flash programming is not suppressed.

Next, in block 230, the target electronic control unit 108a flashes the target software in the target electronic control unit, e.g., according to conventional flash programming techniques.

Next, in decision block 235, the target electronic control unit 108a determines a flashing outcome by determining whether the target software was successfully updated (i.e., flash success) or failed to update (i.e., flash failure). For example, conventional flash programming processing can output the outcome. If successful, the process 200 proceeds to a block 240. Otherwise, the process proceeds to a block 260.

In block 240, the target electronic control unit 108a broadcasts that the flash programming was successful (i.e., a flash success), via the vehicle 101 communication network. If the flash programming is successful, communication will be restored between the target ECU 108a and the interconnected ECU 108b.

Next, in decision block 245, the target electronic control unit 108a determines if any trouble codes were generated during flash programming, i.e., the control unit 108a can determine whether any trouble codes were stored in its memory 111 after the initiation of the vehicle flashing mode. If there is a false trouble code stored in the memory 111 of target electronic control unit 108a, the process 200 proceeds to a block 250. Otherwise, the process 200 proceeds to a decision block 275. As explained previously, broadcasting the commencement of the vehicle flashing mode (block 225) can suppress the generation of false trouble codes by other electronic control units 108, because the control units 108 may execute programming to suspend generation of trouble codes involving the target electronic control unit 108a. Decision block 245 results in determining if any false trouble codes were generated by the target electronic control unit 108a itself.

In block 250, the target electronic control unit 108a erases the false trouble code from its memory 111.

In block 260, which may follow decision block 235 if the target software failed to be updated (a flash failure), the target software is restored to a previous state, e.g., according to conventional flashing techniques.

Next, in block 265, the target electronic control unit 108a broadcasts the flashing outcome that the software failed to update (i.e., a flash failure).

In decision block 270, which may follow block 250 or block 265, the target electronic control unit 108a determines if there are any existing diagnostic trouble codes stored in the backup memory (e.g., memory 111a, 111b, 111c). If there are one or more diagnostic trouble codes stored in the backup memory, the process proceeds to a block 275. Otherwise, the process proceeds to a block 280.

In block 275, the target electronic control unit 108a restores the one or more existing diagnostic trouble codes from the backup memory. The existing diagnostic trouble code(s) can be restored from backup following broadcast of the flash failure, following the erasure of the false trouble code, or following the determination that the memory 111 does not include the false trouble code. As a result, the existing diagnostic trouble codes are preserved.

Next, in block 280, the target electronic control unit 108a transmits a notification of the flash outcome (e.g., that the target software was successfully updated (“flash success”) or that the target software failed to update (“flash failure”)). The process 200 ends following the block 280.

### CONCLUSION

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, data collector measurements, computations, processing time, communications time, etc.

Computers 105 generally each include instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computer 105 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory.

Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 200, one or more of the steps could be omitted, or the steps could be executed in a different order than shown, unless otherwise indicated. In other words, the descriptions of systems and/or processes herein are provided for the purpose of illustrating certain embodiments and should in no way be construed so as to limit the disclosed subject matter.

All terms used in the claims are intended to be given their plain and ordinary meanings as understood by those skilled in the art unless an explicit indication to the contrary is made herein. In particular, use of the singular articles such as “the”, “said”, etc. should be read to recite one or more of the indicated elements unless a claim recites an explicit limitation to the contrary. The terms “first” and “second” should not be construed to recite only two. The phrase “based on” encompasses being partly or entirely based on.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

1. A first electronic control unit (ECU) in a vehicle, comprising a processor, and a memory storing instructions, executable by the processor to:
receive, in the first ECU, a software update or a message notifying of the software update;
broadcast a flash initiation message via a vehicle communications network to one or more second ECUs, specifying an intent to perform a flash to apply the software update in the first ECU;
flash the software update in the first ECU; and
broadcast a flash outcome via the vehicle communication network including a flash success or a flash failure.

2. The first electronic control unit of claim 1, further programmed to:
store in the memory of the first ECU a diagnostic trouble code generated during the flash.

3. The first electronic control unit of claim 1, further programmed to:
receive and store in the memory of the first ECU a diagnostic trouble code existing in the memory prior to flash.

4. The first electronic control unit of claim 3, further programmed to:
back up the diagnostic trouble code in a memory partition section of the memory of the first ECU prior to broadcast of the flash initiation message.

5. The first electronic control unit of claim 2, further programmed to: erase from the memory of the first ECU the diagnostic trouble code generated during the flash.

6. The first electronic control unit of claim 5, further programmed to determine if the memory of the first ECU includes the diagnostic trouble code generated during the flash following broadcast of the flash success.

7. The first electronic control unit of claim 6, further programmed to:
restore the diagnostic trouble code from backup following broadcast of the flash failure, following the erasure of the diagnostic trouble code generated during the flash, or following the determination that the memory of the first ECU does not include the diagnostic trouble code generated during the flash.

8. A system, comprising:
a first electronic control unit (ECU), including a processor, and a second ECU, in a vehicle, wherein the first ECU is programmed to:
receive a software update or a message notifying of the software update;
broadcast a flash initiation message via a vehicle communications network for receipt by other ECUs, specifying an intent to perform a flash to apply the software update in the first ECU;
flash the software update in the first ECU; and
broadcast a flash outcome including a flash success or a flash failure; and
wherein the second electronic control unit is communicatively coupled to the first electronic control unit via the vehicle communications network to receive messages from the first ECU.

9. The system of claim 8, wherein the first electronic control unit is further programmed to:
store in a memory a diagnostic trouble code generated during the flash.

10. The system of claim 8, wherein the first electronic control unit is further programmed to:
receive and store in a memory a diagnostic trouble code existing in the memory prior to flash.

11. The system of claim 10, wherein the first electronic control unit is further programmed to: backup the diagnostic trouble code in a memory partition section of a memory prior to the flash initiation broadcast.

12. The system of claim 9, wherein the first electronic control unit is further programmed to:
erase from a memory of the first ECU the diagnostic trouble code generated during the flash.

13. The system of claim 12, wherein the first electronic control unit determines if a memory includes the diagnostic trouble code generated during the flash following broadcast of the flash success.

14. The system of claim 13, wherein the first electronic control unit is further programmed to:
restore the diagnostic trouble code existing in a memory prior to flash from backup following broadcast of the flash failure, following the erasure of the diagnostic trouble code generated during the flash, or following the determination that the memory does not include the diagnostic trouble code generated during the flash.

15. A method comprising, by a first electronic control unit (ECU) in a vehicle:
receiving, in the first ECU, a software update or a message notifying of the software update;
broadcasting a flash initiation message via a vehicle communications network to one or more second ECUs, specifying an intent to perform a flash to apply the software update in the first ECU;
flashing the software update in the first ECU; and
broadcasting a flash outcome via the vehicle communication network, including a flash success or a flash failure.

16. The method of claim 15, further comprising storing in a memory a diagnostic trouble code generated during flashing.

17. The method of claim 15, further comprising:
receiving and storing in the memory a diagnostic trouble code existing in a memory prior to flashing.

18. The method of claim 17, further comprising:
backing up the diagnostic trouble code in a memory partition section of the memory prior to broadcasting flash initiation.

19. The method of claim 16, further comprising, after broadcasting the flash success:
erasing from the memory the diagnostic trouble code generated during the flash.

20. The method of claim 19, further comprising:
restoring the diagnostic trouble code existing in the memory prior to flash from backup following broadcasting of the flash failure, following erasing of the diagnostic trouble code generated during the flash, or following determining that the memory does not include the diagnostic trouble code generated during the flash.
